(19) United States
(12) Patent Application Publication
(10) Pub. No.: US 2005/0224584 A1
(43) Pub. Date: Oct. 13, 2005

(54) Grocery list with coupons and advertising opportunities

(76) Inventor: David Schulteis, St. Paul, MN (US)

Correspondence Address: OPPENHEIMER WOLFF & DONNELLY LLP, 45 SOUTH SEVENTH STREET, SUITE 3300, MINNEAPOLIS, MN, 55402, US

(21) Appl. No.: 11/098,232

(22) Filed: Apr. 4, 2005

Related U.S. Application Data
(60) Provisional application No. 60/560,574, filed on Apr. 8, 2004.

(51) Int. Cl. G06K 15/00; G06K 19/00; G06K 19/06

(52) U.S. Cl. 235/487; 235/494; 235/383

(57) ABSTRACT

A customized grocery list divided into a series of generic categories is arranged in a route typically taken by a customer walking through the store. Each category may include one or more listed products. Some products may be licensed so that a specific brand is listed. The grocery list includes marketing/advertising regions for product and service providers. Indicators, such as graphical icons, are used to denote food products on the list meeting certain criteria, such as “low carb” or “organic”. The list may also include spaces to enable a customer to write in his preferred brand or a product not already listed. Some of the products have special offers listed for them. The grocery list includes a bar code or other identifier. The bar code or other identifier is used at check-out to award the customer with the applicable special offers or coupons

### BACKGROUND OF THE INVENTION

The grocery store industry operates with low profit margins against a large number of competitors. Grocers adopt various features and perks to encourage their customers to return for future shopping needs. For example, some grocery chains issue loyalty club cards to customers and when customers present the cards they may receive special coupon discounts on various products. Other grocery chains may offer 24-hour service, a wider variety of products, lower prices, double coupons, and other attractive features in their quest to increase repeated visits from customers.

In addition to such customer loyalty concerns, grocery stores work to increase their revenue through means other than the sale of their food products. For example, they may charge manufacturers a shelf fee to feature the manufacturers' products. Another way to increase revenue is by renting a small portion of the store to other businesses, such as banks or coffee houses.

Manufacturers themselves work to sell their products to the grocery store customers. Manufacturers may print coupons in local papers or may produce television commercials to encourage sales. With so many new products offered each year, manufacturers face additional pressure for their brands to attract the attention of the consumer.

While grocers work to attract customers and while manufacturers work to sell their brands, the customers often look for competitive pricing, friendly service, a wide range of products, and an easy shopping trip.

A need exists for an innovation that attracts future visits from a grocery store's customers. What is needed is a way to integrate the advertisement of certain brands with the shopping experience. What is also needed is a way to help customers during their shopping to make the visit easier and more enjoyable.

### SUMMARY OF THE INVENTION

The current invention provides a customized checklist and method that addresses the aforementioned needs. The current invention provides a customized checklist having product information, where the product information is summarized in generic categories and arranged in a route typically taken by customers walking through a store. In one embodiment, product and service providers may purchase marketing or advertising regions to display information on the customized checklist. In another embodiment, the customized checklist may include indicators about various food criteria. Some of the products can have special offers listed for them. The grocery list may include a bar code or other identifier. The bar code or other identifier is then used at check-out to award the customer with the applicable special offers or coupons.

The present invention provides a method in a computer system for developing a customized checklist including gathering information about specific products and configurations of individual stores, summarizing the product information in generic categories, configuring checklists such that products are arranged in a route typically taken by customers walking through the store, and providing marketing and advertising regions for product and service providers on the checklist.

### BRIEF DESCRIPTION OF THE FIGURES

FIG. 1 is a sample list made available under the present invention.

FIG. 2 is a flowchart of the method of one embodiment of the present invention.

FIG. 3 is the front page of a sample customized list generated according to a method of the present invention.

FIG. 4 is the back page of a sample customized list generated according to a method of the present invention.

### DETAILED DESCRIPTION OF THE PREFERRED EMBODIMENTS

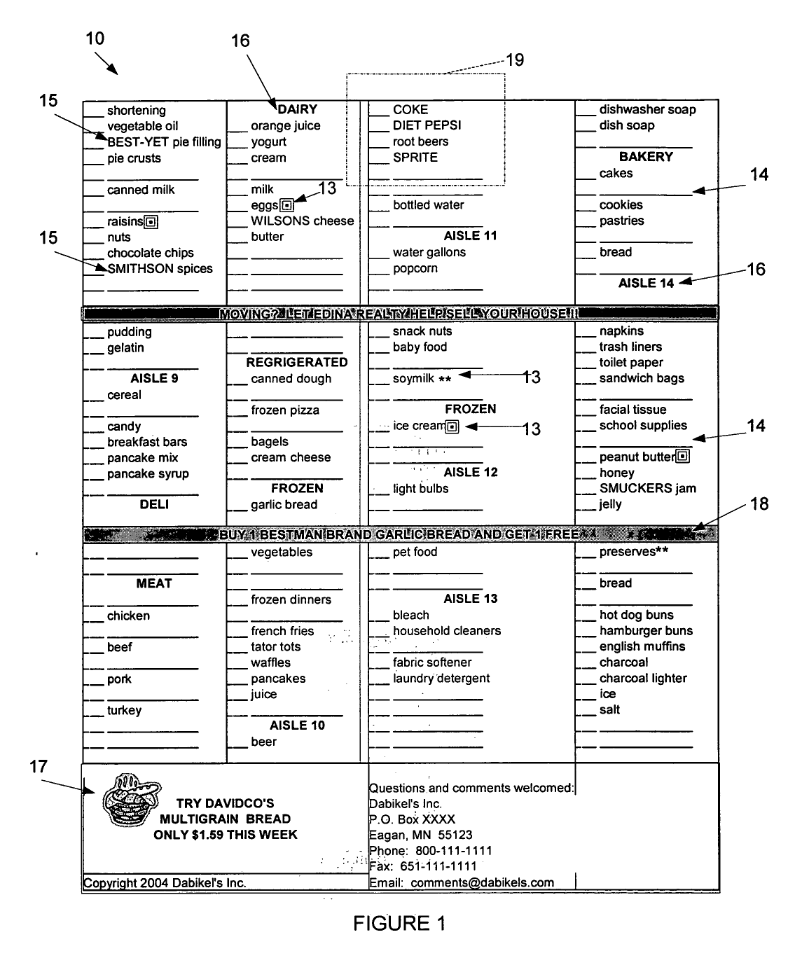

Referring now to the figures, and first to FIG. 1, there is shown a list 10 of the present invention. FIG. 1 shows a partial listing for a grocery store, starting with shortening and vegetable oil and ending with ice and salt. The list 10 is developed for a specific store and condenses the large number of products down to a manageable number of product categories (such as pie crusts, canned milk and raisins). These generic categories are presented on the list by aisle or department 16 and are sorted in the order a typical customer may use when shopping a store, such as from the entrance, through the produce, deli, and freezers, through more aisles and then to the checkout lanes.

Rights to some of the generic categories on the list 10 are assigned to various manufacturers so that their specific brands may be shown. For example, the list in FIG. 1 includes “BEST-YET pie filling” 15 and “SMITHSON spices” 15 in the first column. Blank spaces 14 are also included within the list, allowing a customer to write in specific items not identified on the list.

A preferred embodiment of the invention may also include indicators 13 that are used to point out which items meet various criteria. For example, a heart icon may be used to indicate foods that have been designated as “heart friendly”. Another indicator may be used to indicate items that are allowed on the Atkins diet. Yet another indicator may show which items are certified organic.

A preferred embodiment of the list 10 also includes marketing or advertising regions 17 and 18. Marketing or Advertising regions 17 and 18 are also available for purchase by any business chosen by the storeowner or the generator of the lists 10. Marketing or advertising regions 17 and 18 are not associated with an aisle and do not have to pertain to an item available for purchase in the store. For example, a local movie theater may advertise in one of the marketing or advertising regions 17 and 18.

A home office 22 may be set up to provide the list service and to coordinate all activities associated with the list. A group of readers 24 may be employed by the home office and stationed across a desired service area, such as the United States. The readers 24 may be responsible for inputting data pertaining to each individual store, namely, the products offered for sale and the aisles in which the products are located. In “reading” the products in the store, the readers 24 may follow a route that is typically followed by a customer.

The home office 22 may also employ one or more input clerks 26. The input clerks 26 may be responsible for compiling the data provided by the readers and generating the customized lists 10.

A group of trainers 28 may be employed by the home office 22 to go to the grocery stores to train the cashiers and managers on how to promote the use of the customized lists.

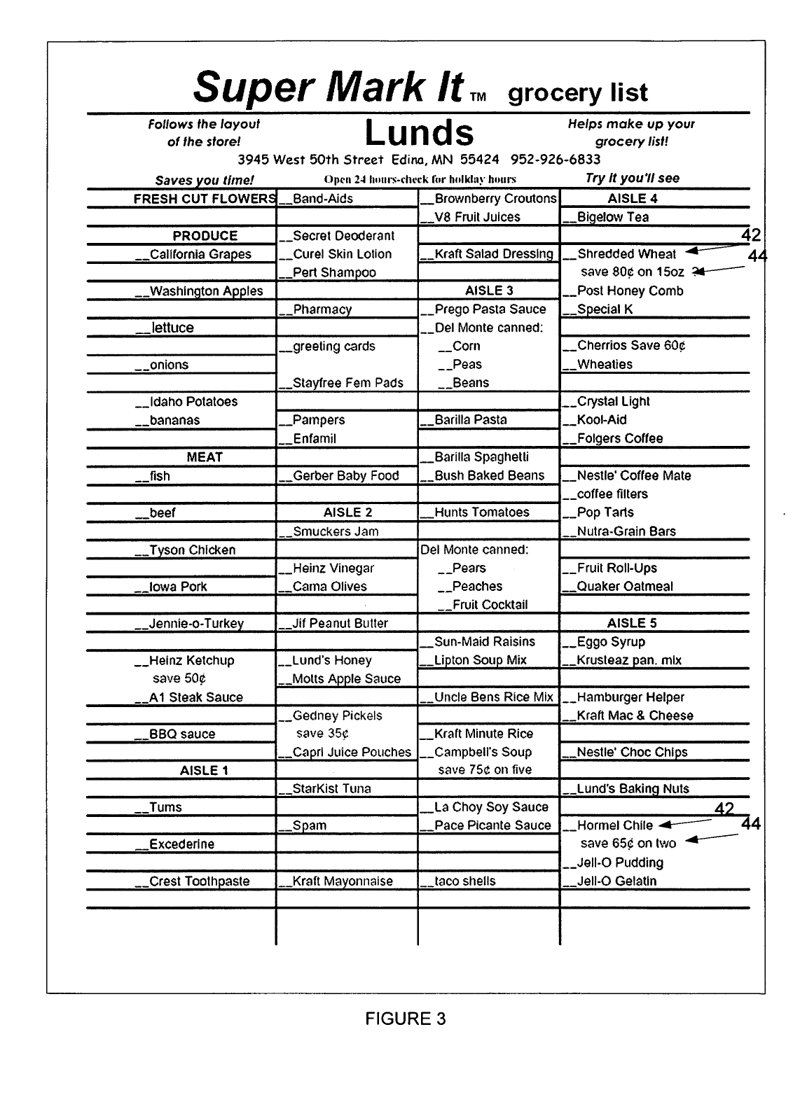

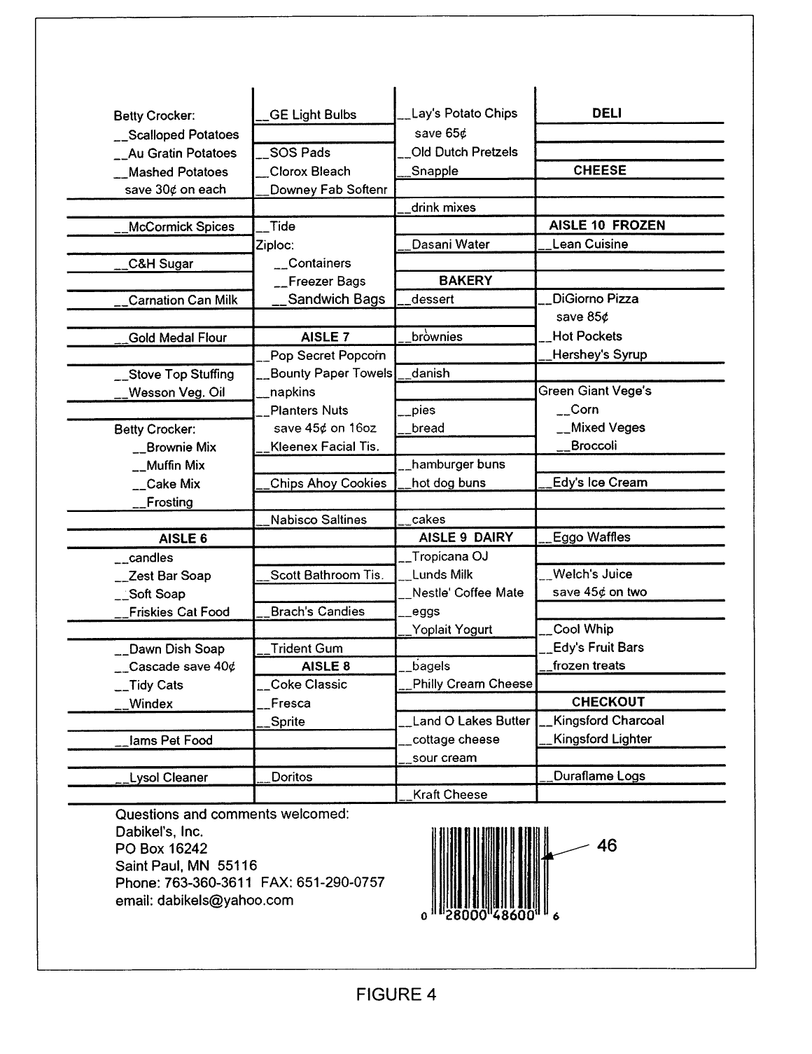

FIGS. 3 and 4 illustrate another form of a customized list generated by a method of the present invention. This embodiment of the list transforms the list with embedded coupons to be redeemed by the customer. As shown in FIG. 3, the coupon item 42 is highlighted in a color such as blue to differentiate it from the other items on the list. The coupon deal 44, such as the discounted amount is highlighted in red just below it. To redeem the coupon the cashier reads the bar code 46 (FIG. 4) on the back of the grocery list. The store's point of sale software recognizes this bar code 46 or other identifier and adjusts the coupon amount for each product purchased that is advertised with a coupon offer.

Couponing in the way shown in FIGS. 3 and 4 is an economical method in comparison to current coupon methods. Presently, the coupon is printed in a newspaper flier or some such other print. The reader of the newspaper then needs to cut out the coupon (or even a handful of coupons) and then remember to redeem them at the store before the expiration date. A very low percentage of these coupons are redeemed. The cost to the manufacturers for these coupons is very high since they first pay for the print ad and then have to reimburse the stores for the coupon amount plus a handling charge. In addition, the manufacturers must pay a coupon clearing house to count and sort the coupons. In the present invention shown in FIGS. 3 and 4, the process is simplified for both the consumer and the manufacturer.

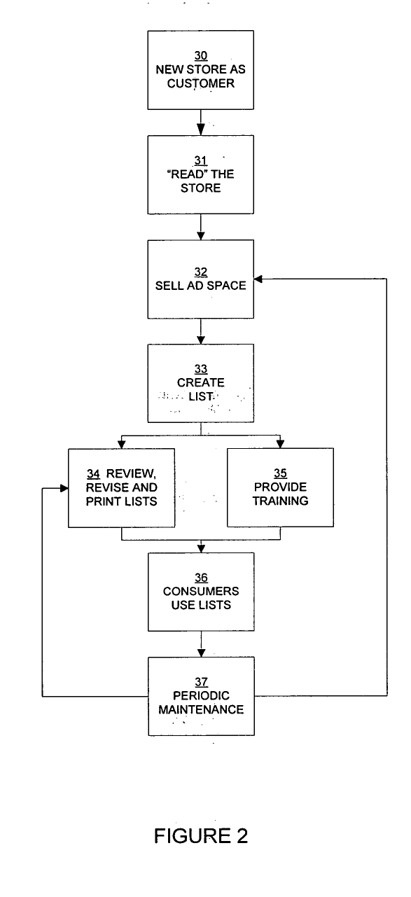

As shown in the flowchart of FIG. 2, in one embodiment, the method of the present invention may begin by contacting grocery stores, and grocery store chains, to gain them as new customers to the implementation of the customized lists 30. Preferably, the person in charge of advertising for an entire grocery chain is contacted during this step. Similarly, product manufacturers are contacted to solicit the purchase of marketing or advertising regions, either in the form of branding rights to a product category 15 or rights to the marketing or advertising regions 17 and 18.

Having identified stores wishing to purchase a customized list 10, readers 24 are sent, preferably via e-mail, a list of stores to be “read” 31. Preferably, the list of stores is provided in an order that, if followed, results in minimized drive time for the reader 24. The readers 24 may even be provided with vehicle GPS capabilities to allow the readers 24 to find the stores efficiently.

Each store is then “read” by a reader 24 using a portable bar code reader connected to a PDA with custom software installed. The bar code reader allows a list of all available products to be generated quickly. In addition to the products available, information will be gathered such as store name, address, telephone number, store hours, aisle numbers, department names, and product layout information. The reader 24 will gather this information in a manner similar to the way a typical shopper would walk through the store.

In a separate activity, area merchants, brand owners, and other potential parties are contacted for the sale of marketing or advertising space 32. As outlined above, marketing or advertising regions 17 and 18 on the lists may be sold for display style ads, for tagline style ads that are to be embedded within the lists, and for branding rights 15 for the products types included in the lists. In the branding rights 15 type of marketing or advertising, a brand owner may choose to purchase from one to the maximum number of spaces set aside for a certain product type. For example, the list in FIG. 1 has only five spaces set aside for all sodas 19. In this example, the Coca Cola company has purchased the rights to the cola soda and citrus soda categories and has branded these categories as COKE and SPRITE. The Pepsi Cola company has purchased branding rights to the diet soda category and has branded this category as “DIET PEPSI”. A fourth and fifth category have not been purchased and the fourth is shown generically as “root beers” and the fifth is shown as a blank space to allow the customer to write in his or her preferred brand.

After the reader 24 gathers the information, the collected data is sent to the home office computer. Here, an input clerk 26 creates the lists 10, preferably using customized software 33. The list input clerk 26 then sends a first draft of the list 10 to the owner of the store for approval and editing 34. Upon approval the lists 10 are printed and shipped to the owner for distribution to the customers. The lists 10 is printed at a printing service, preferably located near the store.

Initial implementation at a store may include a visit by a trainer 28. The trainer 28 is responsible for training the cashiers and store managers on how to promote the lists using “word of mouth” 35.

A training video is produced to train store cashiers on how to talk to customers about using the lists. In one embodiment, the training video is short in duration, preferably 10 to 15 minutes long, in order to encourage viewing. In one embodiment, a small video monitor with playback capability, such as a DVD player, is provided for placement in a room, such as an employee break room, so that newly hired cashiers can watch the instructional video to train them on how to talk to the customers to promote the lists. Such training may increase the use of the lists by consumers in their subsequent visits to the grocery store 36.

The lists may be periodically maintained 37. List accuracy may be maintained 36 by such measures as: trainers visiting each store every 30 to 90 days to walk the store with the list to verify list accuracy; store management notifying the home office 22 of changes as they arise; and encouraging customers to notify either the store or the home office if discrepancies are noted. In addition to list accuracy, the sale of marketing or advertising regions is an ongoing process.

This description and the corresponding drawings illustrate various embodiments of the invention but one skilled in the art will recognize that variations and alternative embodiments may be practiced without parting from the scope of the invention.

1. A checklist that is customized for a particular store, comprising:
a plurality of categories representing products for sale in the store, wherein the categories are arranged in a route typically taken by customers walking through the particular store;
marketing regions for product and service providers;
at least one coupon offer; and
a bar code,
wherein details of the coupon offer are associated with the bar code.

2. The checklist of claim 1, further comprising a series of location identifiers to assist in locating the categories.

3. The checklist of claim 2, wherein the location identifiers comprise aisles.

4. The checklist of claim 2, wherein the location identifiers comprise store departments.

5. The checklist of claim 1, wherein at least one of the categories is a brand name.

6. The marketing regions of claim 1, wherein the marketing regions are not associated with the aisles in the store and do not pertain to any products sold in the store.

7. The checklist of claim 1, further comprising at least one icon displayed with at least one of the categories, wherein each of the at least one icon represents a product criteria.

8. The checklist of claim 7, wherein one of the at least one icons represents heart friendly foods.

9. The checklist of claim 7, wherein one of the at least one icons represents special diet foods.

10. The checklist of claim 1, further comprising a plurality of lines for allowing a customer to write in a preferred brand.

11. A method in a computer system for developing a checklist that is customized for a particular store, the method comprising:
gathering information about products and configurations of the particular store;
summarizing the information as a plurality of categories representing products for sale in the store;
configuring the checklist such that the categories are arranged in a route typically taken by customers walking through the particular store;
providing marketing regions for product and service providers on the checklist;
embedding at least one coupon offer in the checklist; and
printing a bar code on the checklist,
wherein details of the coupon offer are associated with the bar code.

12. The method of claim 11, further comprising providing a series of location identifiers to assist in locating the categories.

13. The method of claim 12, wherein the location identifiers comprise aisles.

14. The method of claim 12, wherein the location identifiers comprise store departments.

15. The method of claim 11, wherein at least one of the categories is a brand name.

16. The method of claim 11, wherein the marketing regions are not associated with the aisles in the store and do not pertain to any products sold in the store.

17. The method of claim 11, further comprising displaying on the checklist an icon displayed with at least one of the categories, wherein the icon represents a product criteria.

18. The method of claim 11, further comprising inputting data associated to the categories.

19. The method of claim 11, further comprising training store employees on the use of the customized checklists.

20. The method of claim 11, further comprising selling rights to the marketing regions.
